(19) United States
(12) Patent Application Publication
(10) Pub. No.: US 2026/0236791 A1
(43) Pub. Date: Aug. 13, 2026

(54) METHOD FOR DETERMINING AT LEAST ONE PHYSICAL VALUE IN DATA AND ASSOCIATED PRODUCTS

(71) Applicants: INSTITUT NATIONAL DE LA SANTE ET DE LA RECHERCHE MEDICALE, Paris (FR); CENTRE NATIONAL DE LA RECHERCHE SCIENTIFIQUE, Paris (FR); UNIVERSITE TOULOUSE III-PAUL SABATIER, Toulouse Cedex 9 (FR); UNIVERSITE TOULOUSE II, Toulouse (FR); UNIVERSITE TOULOUSE CAPITOLE, Toulouse (FR); INSTITUT SUPERIEUR DE L'AERONAUTIQUE ET DE L'ESPACE (ISAE), Toulouse (FR)

(72) Inventors: Kévin CORTACERO, Toulouse Cedex 1 (FR); Salvatore VALITUTTI; Sylvain CUSSAT-BLANC, Toulouse (FR); Dennis WILSON, Toulouse Cedex 4 (FR); Hervé LUGA, Toulouse (FR); Brienne MCKENZIE, Toulouse Cedex 1 (FR)

(21) Appl. No.: 19/154,165

(22) PCT Filed: Feb. 9, 2024
(86) PCT No.: PCT/EP2024/053346

§ 371 Date: Aug. 6, 2025

(30) Foreign Application Priority Data
Feb. 9, 2023 (EP) 23305172.1

(51) Int. Cl. G06N 3/126; G06V 10/20; G06V 10/48

(52) U.S. Cl. CPC G06N 3/126; G06V 10/255; G06V 10/48; G06V 2201/03

(57) ABSTRACT

The present invention relates to the field of biological and medical imaging. In this field, one key issue is the burden linked to the labelling of images. The inventors have developed a new pipeline enabling to circumvent this issue by using a specific cartesian genetic programming. The resulting method provides with improved performance for imaging and drastically reduces the need for labelled images.

### TECHNICAL FIELD OF THE INVENTION

The present invention concerns a method for determining at least one physical value in data. The invention also relates to the associated computer program product and computer readable medium.

### BACKGROUND OF THE INVENTION

In biology and medicine, current imaging techniques produce tremendous number of images that exhibit great diversity and complexity and need to be processed, analyzed and quantified to provide meaningful interpretation of biological events and clinical processes.

Nowadays, the bottle-neck of this process is the human power that is required for image evaluation, interpretation and annotation.

In addition, the human nature imposes ways of reasoning that can affect the objectivity of the statistical measures that need to be extracted from the images to validate or invalidate a given hypothesis.

In parallel with the development of imaging techniques, engineers and researchers designed many image filters and analysis pipelines that served as useful tools to assist experimentalists in their image quantification tasks.

Nevertheless, filters and pipelines need a certain level of expertise in order to be used at best, requiring biologists to master the state-of-the-art algorithms in computer vision.

The development of artificial intelligence (named under the abbreviation AI hereinafter), and more specifically deep learning approaches, allowed to make a step forward in image analysis and revolutionized the entire field of computer vision. For instance, artificial intelligence has been proved competitive with human expertise in medical image analysis including, but not limited, to cardiology, dermatology, ophthalmology, radiology and pathology.

However, one limitation of these techniques is that they require data sets that comprise thousands of precisely annotated images in order to be efficient. Indeed, artificial neural networks (named under the abbreviation ANN or ANNs hereinafter) are conceived to work at the pixel level to generate from scratch filters and pipelines without being able to build on previous human knowledge and experience.

As a consequence, ANNs require huge computational efforts to provide satisfactory solutions. ANNs are composed of thousands of simple computational units, the neurons, which are connected in a complex network of weighted interactions.

Designing the architecture of such a network is a key step before training. Training an ANN to solve a given task requires the optimization of millions of parameters all together. At the end, the obtained networks are hard to analyze and interpret in spite of the huge progresses that have been recently performed in the field of “explainable AI”. Limited interpretability might be viewed as a potential drawback, in particularly in medicine, where the diagnostic process needs to be fully interpretable.

An additional limitation of ANNs is that it is presently difficult to interfere with the parameters during the learning stage to inject human knowledge and experience. Transfer learning allowed to make a first step forward in this direction by training a generalist network on a diversified data set and specializing this network on a specific task.

Additional progresses in this direction are expected to further reduce the computational efforts and, more importantly, the number of the required annotations, thus making AI more operational in the field of biological and medical image analysis.

### SUMMARY OF THE INVENTION

There is therefore a need for a method for instance-segmenting in biological and medical imaging, and more generally of a method for determining at least one physical value in data, which limits the number of required annotated training data.

To this end, the specification describes a method for determining at least one physical value in data, the method being computer-implemented, the method for determining comprising:
a training phase during which a converting function of a device for determining at least one physical value in data is trained, the device being adapted to apply:
   an estimating function adapted to estimate the at least one physical value based on input data, and
   a conversion function on incoming data to obtain input data for the estimating function,
the training phase comprising the steps of:
   obtaining a dataset whose elements are incoming data and the corresponding physical value and a set of predefined operations, and
   implementing cartesian genetic programming on the set of predefined operations and the dataset to obtain a trained conversion function maximizing a performance criteria for the device for estimating,
a use phase during which the trained conversion function is used, the use phase comprising the steps of:
   providing real incoming data,
   applying the trained conversion function on the real incoming data, to obtain real input data, and
   applying the estimating function on the real input data, to obtain the estimated physical value.

According to further aspects of the method for determining, which are advantageous but not compulsory, the method might incorporate one or several of the following features, taken in any technically admissible combination:
each real incoming data are data coming from a sensor.
each data is an image.
each data has a specific format, each operation of the set of operations keeping the format between the data inputted to the operation and the data outputted by the operation.
each data has a specific format, the format of the incoming data being different from the format of the input data inputted to the estimating function.
determining at least one physical value in data corresponds to a task, the task being chosen among counting, segmentation, instance segmentation, generation, classification, and denoizing.
the task is the identification of biological objects in an environment.
the task is the instance-segmentation of biological objects in an environment.
the biological objects are cells or subcellular particles.
each operation of the set of predefined operations is chosen among a filter, a morphological operation and an element-wise operator.
the estimating function is a Watershed function.
the estimating function is a Circle Hough Transform.
the performance criteria is minimizing the error in the determination of the at least one physical value.

The specification also concerns a computer program product comprising instructions which, when the program is executed by a computer, cause the computer to carry out the steps of a method as previously described.

The specification further describes a computer-readable storage medium comprising instructions which, when executed by a computer, cause the computer to carry out the steps of a method as previously described.

### BRIEF DESCRIPTION OF THE DRAWINGS

The invention will be better understood on the basis of the following description which is given in correspondence with the annexed figures and as an illustrative example, without restricting the object of the invention. In the annexed figures:

FIG. 1 shows schematically a system and a computer program product which interaction enables to carry out a method for instance-segmenting biological objects in an environment,

FIG. 2 is a flowchart illustrating a specific example of carrying out a method for instance-segmenting biological objects in an environment and a representation of the result obtained at the end of some step of this method for instance-segmenting,

FIG. 3 is a schematic representation of an example of genome used in the method for instance-segmenting,

FIG. 4 is a schematic representation of the graph corresponding to the genome of FIG. 3,

FIG. 5 is a schematic representation of the connection between the graph of FIG. 4 and the instance-segmenting operation, and

FIGS. 6 to 16 are relative to an experiment carried out by the Applicant.

### DETAILED DESCRIPTION OF THE PREFERRED EMBODIMENTS

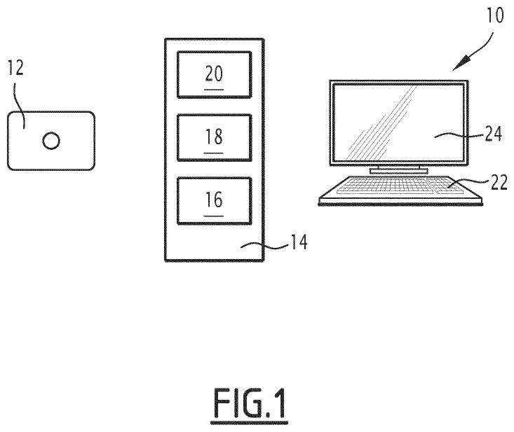

A system 10 and a computer program product 12 are represented in FIG. 1. The interaction between the computer program product 12 and the system 10 enables to carry out a method for instance-segmenting biological objects in an environment.

The method for instance-segmenting is thus a computer-implemented method.

System 10 is a computer. In the present case, system 10 is a laptop.

More generally, system 10 is a computer or computing system, or similar electronic computing device adapted to manipulate and/or transform data represented as electronic quantities within the computing system's registers and/or memories into other data similarly represented as physical quantities within the computing system's memories, registers or other such information storage, transmission or display devices.

System 10 comprises a processor 14, a keyboard 22 and a display unit 24.

The processor 14 comprises a data-processing unit 16, memories 18 and a reader 20. The reader 20 is adapted to read a computer readable medium.

The computer program product 12 comprises a computer readable medium.

The computer readable medium is a medium that can be read by the reader of the processor. The computer readable medium is a medium suitable for storing electronic instructions, and capable of being coupled to a computer system bus.

Such computer readable storage media are, for instance, disks, floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of medium for storing electronic instructions, and able to be coupled to a computer system bus.

A computer program is stored in the computer readable storage medium. The computer program comprises one or more stored sequences of program instructions.

The computer program is loadable into the data-processing unit and adapted to cause execution of the method for determining when the computer program is run by the data-processing unit.

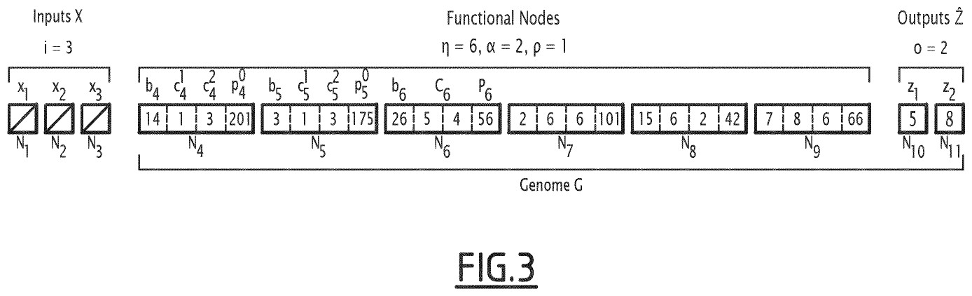

Operation of the system 10 is now described in reference to the flowchart of FIG. 3, which illustrates an example of carrying out the method for instance-segmenting.

The method for instance-segmenting aims at identifying and locating biological objects in images.

The biological objects are, for instance, cells or subcellular particles such as extracellular vesicles, organelles, cytoskeleton, cell-cell synapses, etc.

The images may any kind of images enabling to provide an image of the cells. In particular, microscopy images may be specifically considered.

According to this example, the method for instance-segmenting comprises two phases: a training phase P1 and a use phase P2.

The training phase P1 aims at obtaining a device for instance-segmenting 26 adapted to instance-segment images.

The device for instance-segmenting 26 is adapted to carry out several operations.

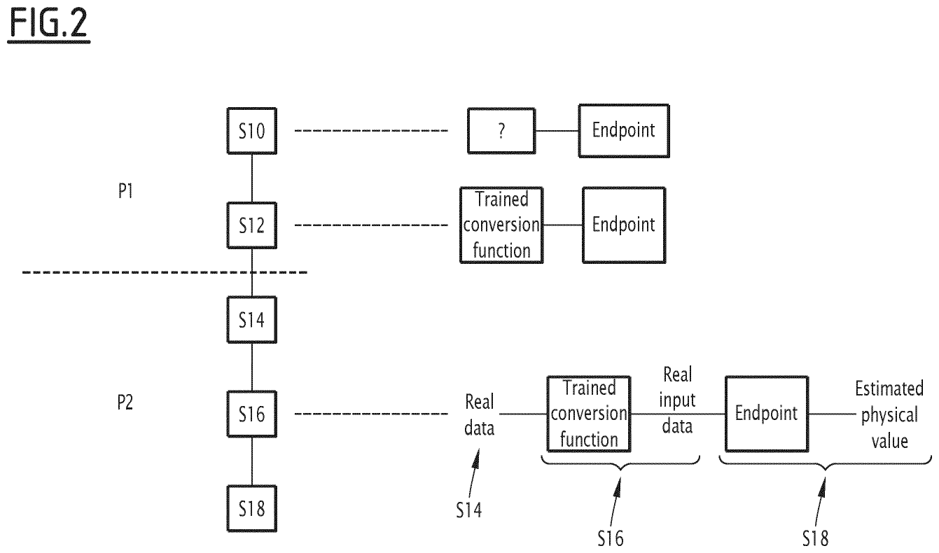

In the present example, as illustrated schematically on FIG. 2, the device for instance-segmenting 26 is adapted to:
receive first images on which instance-segmenting is to be carried out,
apply a conversion function on the first images to obtain second images for the estimating function, and
apply an estimating function on the second images to obtain the result of instance-segmenting of the first images.

The conversion function is the function to be trained during the training phase while the estimating function is a function which is provided as an input.

As a specific example, the estimating function is a Watershed function.

Alternatively, the estimating function is a Circle Hough Transform.

Details about this function can be found in the article entitled “A survey of the hough transform” written by J. Illinworth et al.

However, any interesting estimating function can be used in this context.

The only requirement is that the result of the estimating function be the result searched for with the method and to know the kind of inputs required by the estimating function.

In the present case, the training phase P1 comprises a step of obtaining S10 and a step of implementing S12.

During the step of obtaining S10, the system 10 obtains a dataset and a set of predefined operations.

The dataset comprises elements in the form of couple of image and the content of the image.

The images have the format of the first images.

The content of the image is here the result of the instance-segmentation, namely what is the content of each pixel.

This pixel is thus identified as being a pixel of a biological object and which one or not a biological object.

The set of predefined operations gather operations keeping the format between the image inputted to the operation and the image outputted by the operation.

The format of an image designates the geometrical format (namely the number of pixels and its arrangement) as well as the nature of the data. For instance, the channel used for the image is a format data. Namely, a color image (3 channel image) is different from a gray image (1 channel image).

The operations can be construed as mathematical functions, the term “function” or “operation” will thus be used for designating this element.

It should be understood that the operation is here any operation, an operation coming from a library, an operation designed on purpose, a conversion function resulting from the carrying out of the training phase P1 or a network neuron.

The number of operations may be any one, but preferably a set of more than 10 operations, and even more preferably more than 20 operations is advantageous.

For instance, each operation of the set of predefined operations is chosen among a filter, a morphological operation and an element-wise operator.

In the described specific example, the set of operations consists of the operation given in the following table.

TABLE 1
List of operations used in the present example

| Operation | Index | Symbol | Arity⁽¹⁾ | Parameters⁽²⁾ | Sources |
|---|---|---|---|---|---|
| max | 1 | MAX | 2 | 0 | OpenCV⁽²⁾ |
| min | 2 | MIN | 2 | 0 | OpenCV |
| mean | 3 | MEAN | 2 | 0 | OpenCV |
| add | 4 | ADD | 2 | 0 | OpenCV |
| subtract | 5 | SUB | 2 | 0 | OpenCV |
| bitwise not | 6 | NOT | 1 | 0 | OpenCV |
| bitwise or | 7 | BOR | 2 | 0 | OpenCV |
| bitwise and | 8 | BAND | 2 | 0 | OpenCV |
| bitwise and | 9 | ANDM | 2 | 0 | OpenCV |
| mask | | | | | |
| bitwise xor | 10 | BXOR | 2 | 0 | OpenCV |
| sqrt | 11 | SQRT | 1 | 0 | OpenCV |
| pow2 | 12 | POW | 1 | 0 | OpenCV |
| exp | 13 | EXP | 1 | 0 | OpenCV |
| log | 14 | LOG | 1 | 0 | Numpy⁽⁴⁾ |
| median blur | 15 | BLRM | 1 | 1 | OpenCV |
| gaussian blur | 16 | BLRG | 1 | 1 | OpenCV |
| laplacian | 17 | LPLC | 1 | 0 | OpenCV |
| sobel | 18 | SOBL | 1 | 2 | OpenCV |
| robert cross | 19 | RBRT | 1 | 1 | OpenCV |
| canny | 20 | CANY | 1 | 2 | OpenCV |
| sharpen | 21 | SHRP | 1 | 0 | OpenCV |
| gabor | 22 | GABR | 1 | 2 | OpenCV |
| abs diff | 23 | ABSD | 1 | 2 | OpenCV |
| abs diff2 | 24 | ABS2 | 2 | 0 | OpenCV |
| fluo tophat⁽⁵⁾ | 25 | FLUO | 1 | 2 | Handmade⁽⁶⁾ |
| rel diff⁽⁷⁾ | 26 | RELD | 1 | 1 | Handmade |
| erode | 27 | EROD | 1 | 2 | OpenCV |
| dilate | 28 | DILT | 1 | 2 | OpenCV |
| open | 29 | OPEN | 1 | 2 | OpenCV |
| close | 30 | CLSE | 1 | 2 | OpenCV |
| morph | 31 | MGRD | 1 | 2 | OpenCV |
| gradient | | | | | |
| morph tophat | 32 | MTHT | 1 | 2 | OpenCV |
| morph | 33 | MBHT | 1 | 2 | OpenCV |
| blackhat | | | | | |
| fill holes⁽⁸⁾ | 34 | FILL | 1 | 0 | Handmade |
| remove small | 35 | RMSO | 1 | 1 | Skimage⁽⁹⁾ |
| objects | | | | | |
| remove small | 36 | RMSH | 1 | 1 | Skimage |
| holes | | | | | |
| threshold | 37 | TRH | 1 | 2 | OpenCV |
| threshold at 1 | 38 | TRH1 | 1 | 1 | OpenCV |
| distance | 39 | DRTF | 1 | 1 | OpenCV |
| transform | | | | | |
| distance | 40 | DTTR | 1 | 2 | OpenCV |
| transform and | | | | | |
| thresh | | | | | |
| inrange bin | 41 | BRNG | 1 | 2 | OpenCV |
| inrange | 42 | RNG | 1 | 2 | OpenCV |

⁽¹⁾Arity designates the number of inputs for the operation (here the inputs are the data to process).
⁽²⁾Parameters designate the number of parameters needed in addition to the inputs to carry out the operation. For instance, a power function may take as parameter the value of the power.
(3) Opencv designates a library of operations, which is accessible at the following Internet address: https://docs.opencv.org/4.x/d2/d96/tutorial_py_table_of_contents_imgproc.html
⁽⁴⁾Numpy designates a library of operations, which is accessible at the following Internet address: https://numpy.org/doc/1.20/reference/index.html
⁽⁵⁾fluo tophat designates a function adapted to suppress the noise of the image (background)
⁽⁶⁾Handmade designates a function made on purpose. In practice, it is here a combination of operation taken from the library Opencv and the library Skimage.
⁽⁷⁾rel_diff designates a function adapted to calculate the relative difference between two images to eliminate the artefacts creating blurriness.
⁽⁸⁾fill_holes designates a function adapted to fill the holes in an image. As a specific example, this function applied on a donut gives as output a disk.
⁽⁹⁾Skimage designates a library of operations, which is accessible at the following Internet address: https://scikit-image.org/docs/stable/api/api.html

According to the case, the system 10 can obtain these data by receiving them or reading them in a memory.

In any case, at the end of the step of obtaining S10, the system 10 can use the dataset and the set of predefined operations for further operating.

During the step of implementing S12, the system 10 implements CGP on the set of predefined operations and the dataset.

The abbreviation CGP stands for “Cartesian Genetic Programming”.

Cartesian genetic programming pertains to the field of genetic programming (often named with the abbreviation GP, which is used hereinafter.

GP is based on the artificial evolution of a population of syntactic graphs composed of mathematical functions that, when executed, process given inputs. The generated outputs are evaluated using a human-defined fitness function.

The best syntactic graphs are selected and genetically re-arranged (mutations and crossovers) to produce a new population of syntactic graphs that will be, in turn, evaluated, selected and re-arranged.

The evolutionary pressure will in fine produce a syntactic graph, i.e. a program, adapted to process the input in order to produce the desired output.

GP has been successful to automatically build programs, either from scratch or from existing ones, to solve given problems such as symbolic regression, code generation, debugging/enhancement and image analysis.

While GP directly works on syntactic graphs, Cartesian Genetic Programming (CGP) considers a specific encoding of the syntactic graph within integer-based genome.

The genome of a CGP graph is composed of a set of tuples, each tuple being a node.

The graph is a directed graph in so far as it connects input nodes to output nodes via intermediary nodes.

These nodes are node [symbol] (encoded in a gene) identified with the unique integer value i.

Hereinafter, the inputs nodes are noted x₁, x₂, . . . , xᵢ, ι being the integer designating the number of input nodes.

In short, it can be defined an input vector X, the input vector X verifying:

$$X = [ {x}_{1} , {x}_{2} , … , {x}_{ι} ]$$

These first t nodes are the receiving inputs (e.g. image channels).

The output nodes are noted \hat{z}₁, \hat{z}₂, . . . , \hat{z}ₒ, o being the integer designating the number of output nodes.

In short, it can be defined an output vector \hat{Z}, the output vector \hat{Z} verifying:

$$\hat{Z} = [ {\hat{z}}_{1} , {\hat{z}}_{2} , … , {\hat{z}}_{o} ]$$

The intermediary nodes are functional nodes.

Each functional node Nᵢ is a row vector composed of 3 significant parts described as follows:

$${N}_{i} = \{ {b}_{i} , {C}_{i} , {P}_{i} \}$$

Where:
the integer bᵢ points to one of the operation of the set of predefined operations, the integer bᵢ thus belongs to [symbol] 1, η [symbol] .
Cᵢ are the addresses of upstream nodes within the graph that will be used as inputs for the operation pointed to by the integer bᵢ.
Pᵢ are the parameters that can be used by this operation pointed to by the integer bᵢ in addition to its inputs.

In the present case, each node is determinist and return a 2D image with identical dimensions and type as the input image.

This means that the disclosed method impose a dimension and type preservation conditions for all the nodes, which implies:

$$dim ( X ) = dim ( \hat{Z} ) = dim ( {N}_{i} )$$

An example of genome with its nodes is illustrated in FIG. 3.

In this case, the number of nodes are such that ι=3, η=6 and o=2, resulting in m=11.

In the present case, the input nodes [symbol] , [symbol] and [symbol] correspond to three inputs x₁, x₂ and x₃.

There are 6 functional nodes, which are the nodes [symbol] , [symbol] , [symbol] , [symbol] , [symbol] and [symbol] .

The first functional node [symbol] is such that:

$${N}_{4} = \{ {b}_{4} = 15 , {c}_{4}^{1} = 1 , {c}_{4}^{2} = 3 , {p}_{4}^{0} = 201 \}$$

This means that the first functional node [symbol] applies the operation BLRM on the first input x₁ and the third input x₃.

The second functional node [symbol] is such that:

$${N}_{5} = \{ {b}_{5} = 4 , {c}_{5}^{1} = 1 , {c}_{5}^{2} = 3 , {p}_{5}^{0} = 175 \}$$

This means that the second functional node [symbol] applies the operation ADD on the first input x₁ and the third input x₃.

The third functional node [symbol] is such that:

$${N}_{6} = \{ {b}_{6} = 27 , {c}_{6}^{1} = 5 , {c}_{6}^{2} = 4 , {p}_{6}^{0} = 56 \}$$

This means that the third functional node [symbol] applies the operation EROD on the outputs of the second functional node

[symbol]

The fourth functional node [symbol] is such that:

$${N}_{7} = \{ {b}_{7} = 4 , {c}_{7}^{1} = 6 , {c}_{7}^{2} = 5 , {p}_{7}^{0} = 101 \}$$

This means that the fourth functional node [symbol] applies the operation MEAN on the output of the third functional node [symbol] and the second functional node [symbol] .

The fifth functional node [symbol] is such that:

$${N}_{8} = \{ {b}_{8} = 16 , {c}_{8}^{1} = 6 , {c}_{8}^{2} = 6 , {p}_{8}^{0} = 42 \}$$

This means that the fifth functional node [symbol] applies the operation BRLG on the output of the second functional node [symbol] .

The sixth functional node [symbol] is such that:

$${N}_{9} = \{ {b}_{9} = 8 , {c}_{9}^{1} = 8 , {c}_{9}^{2} = 6 , {p}_{9}^{0} = 66 \}$$

This means that the sixth functional node [symbol] applies the operation BAND on the outputs of the fifth functional node [symbol] and the third functional node [symbol] .

The two output nodes are [symbol] and [symbol] correspond to two outputs \hat{z}₁ and \hat{z}₂.

The first output \hat{z}₁ is equal to 5 while the second output \hat{z}₂ is equal to 8.

This means that the first output \hat{z}₁ is equal to the output of the second functional node [symbol] .

This means that the second output \hat{z}₂ is equal to the output of the fifth functional node [symbol] .

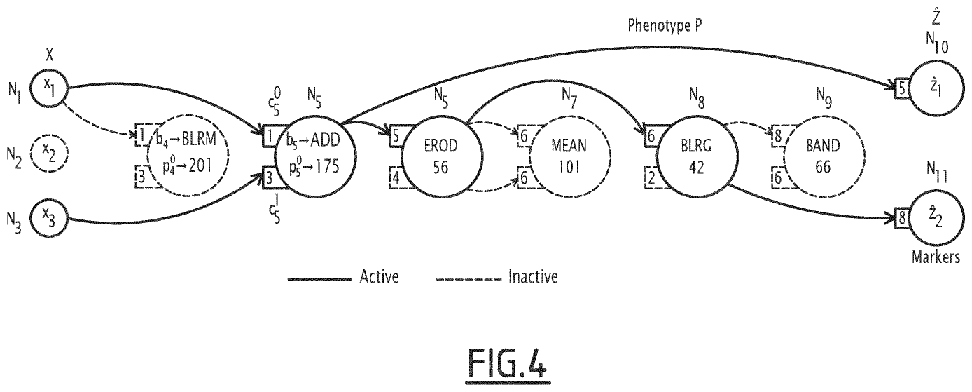

When parsing the genome to a CGP graph, the graph represented on FIG. 4 is obtained.

In this representation, it can be noticed the interactions between nodes are represented either arrows in full line or arrows in dotted line.

The arrows in full line corresponds to active interactions whereas the arrows in dotted line corresponds to inactive interactions.

The interactions are considered as active when they have an impact on the value on one of the outputs \hat{z}₁ or \hat{z}₂ whereas, the interactions with no impact are considered as inactive.

In the present case, this results in the following formulas for the first output \hat{z}₁:

$${\hat{z}}_{1} = ADD ( {x}_{1} , {x}_{3} )$$

Similarly, the second output \hat{z}₂ can be expressed as:

$${\hat{z}}_{2} = BLRG ( EROD ( ADD ( {x}_{1} , {x}_{3} ) , 56 ) , 42 )$$

The outputs \hat{z}₁ and \hat{z}₂ have here the specificity that they are input data for the estimating function.

This means that the outputs \hat{z}₁ and \hat{z}₂ do not provide with the instance-segmentation results.

These outputs \hat{z}₁ and \hat{z}₂ are optimized so that the instance-segmentation achieved by the estimating function be the most efficient possible.

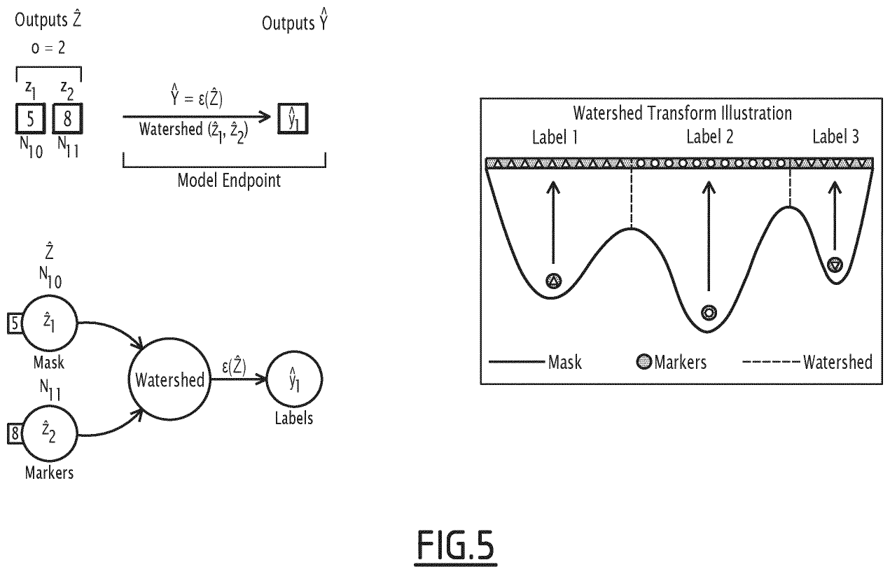

This estimating function is thus used here as an original stage, which is named here the Endpoint (ε). This original stage is schematically represented on FIG. 5.

This corresponds to the fact that the output of the device 20 will be Ŷ such that:

$$\hat{Y} = Watershed ( {\hat{z}}_{1} , {\hat{z}}_{2} )$$

This Endpoint is independent from the genome.

In particular, the Endpoint is the only “node” allowing the outcome size and type to change.

Using this Endpoint means that the CGP is used here not to obtain the instance-segmentation as output but only to provide the estimating function with the best input.

Therefore, the criteria of optimization of the CGP is not to obtain a performance criteria for the instance-segmentation at the output level but on the contrary to maximize a performance criteria for the device for estimating.

The performance criteria can be any performance criteria, such as a minimum number of error and/or a minimum time of calculation.

To be complete, the genome is evolved with a standard 1+λ Evolution Strategy (ES): One genome, the parent, is randomly generated before being evaluated. It then generates λ offspring by mutation, which are also evaluated. The best genome is selected among the parent and its offspring to become the new parent which will, in turn, generate λ new offspring.

The system 10 thus obtains a trained conversion function.

During the use phase P2, the trained conversion function is used.

The use phase P2 comprises a step of obtaining S14 and two steps of applying S16 and S18.

During the step of obtaining S14, an image of the environment is acquired and sent to the system 10.

This environment image is the image on which an instance-segmentation is to be carried out.

During the first applying step S16, the trained conversion function is applied on the environment image to obtain an intermediate image.

During the second applying step S18, the system 10 applies the estimating function on the intermediate image, to obtain the result of the instance-segmentation.

The described method is based on the evolutionary design of pipelines assembled from human engineered filters. This is accomplished by CGP, that generates image analysis pipelines for instance segmentation.

By merging this method-based segmentation with computer vision measures and classical unsupervised machine learning, the Applicant designed a hybrid AI solution to quantitatively analyze immune fluorescence and immunohistochemistry images, as apparent from the experimental section of this specification.

The advantages of using this described method of instance-segmentation can also be drawn from this section. Some of these advantages are given below.

This enables to obtain the result of the instance-segmentation with a robust pipeline, which can be obtained with a limited number of required annotated training data.

The described method also enables to obtain an instance-segmentation with a satisfying accuracy.

The described method is also very flexible since, the Applicant was able to show that the method can be used for diverse instance-segmentation applications, from the automatic detection and characterization of nanometer-scale extracellular vesicles released by CTLs to millimeter-scale detection and classification of cancer nodules in patients' tissue samples passing through the micrometer-scale analysis of various parameters of CTL phenotype and function.

Such flexibility also concerns the inputs.

Indeed, depending on the input images (e.g. transmission light images, fluorescent images, IHC tissues images, etc.) and the expected outcomes (e.g. cell identification, event counting, cell distance and interaction, etc.) needed to address a given biological question, a preprocessing of the data set can be considered.

For instance, for obtaining three-dimensional data, the input becoming a list of formatted inputs:

$${X}_{1 … z} = [ \{ {r}_{1} , {g}_{1} , {b}_{1} \} , … , \{ {r}_{z} , {g}_{z} , {b}_{z} \} ]$$

Therefore, the described method can be used for any task useful in the field of biological and medical imaging, such as identification of biological objects in an environment.

One may consider subcellular particles, cells (cell identification and count) cell-cell synapses, tissue structures, tumor nodules, mouse organs (bone tissue, teeth, etc.) or brain compartments.

Other imaging techniques may be considered, such as MRI modality.

More generally, the method for instance-segmenting corresponds to a specific implementation of a method for determining at least one physical value in data.

In this case, the determination of the at least one physical value in data corresponds to a task, which is instance-segmenting and the physical values determined are the position and identification of the objects.

Indeed, the method described can be applied to other tasks, such as counting, segmentation, generation, classification or denoizing.

For this, it is sufficient to use another estimating function.

For instance, the estimating function is a function adapted to calculate the number of a given element in an image. The task is here the counting and the physical value the number of the given element.

The method for determining can also be applied to other kind of data.

Notably, the method for determining can be used to data coming from a sensor.

For instance, the data may be a signal, such as a radiofrequency signal or a magnetic signal.

In addition, the training phase and the use phase are independent in so far as they can be carried out at several locations. In such case, the systems used for each phase may be different, the systems being able to communicate via a network.

This renders possible to have a centralized training phase and several local use phases.

Therefore, in the more general acceptation, the disclosed method is a computer-implemented method for determining at least one physical value in data, the method being computer-implemented, the method for determining comprising:
a training phase during which a converting function of a device for determining at least one physical value in data is trained, the device being adapted to apply:
   an estimating function adapted to estimate the at least one physical value based on input data, and
   a conversion function on incoming data to obtain input data for the estimating function,
the training phase comprising the steps of:
   obtaining a dataset whose elements are incoming data and the corresponding physical value and a set of predefined operations, and
   implementing a cartesian genetic programming on the set of predefined operations and the dataset to obtain a trained conversion function maximizing a performance criteria for the device for estimating,
a use phase during which the trained conversion function is used, the use phase comprising the steps of:
   providing real incoming data,
   applying the trained conversion function on the real incoming data, to obtain real input data, and
   applying the estimating function on the real input data, to obtain the estimated physical value.

The embodiments and alternative embodiments considered here-above can be combined to generate further embodiments of the invention.

### EXPERIMENTAL SECTION

In the next section, the described method of FIGS. 2 to 5 is compared to the state-of-the-art deep learning techniques applied to cell detection within microscopy images.

To be complete, some additional information relative to the experiment carried out by the Applicant can be found in the Appendix.

### The Described Instance-Segmentation Method Outperforms Mask-RCNN and StarDist and Approaches Cellpose Performance in Instance Segmentation Tasks

In a first step, the Applicant has evaluated the described instance-segmentation method on a known data set to compare its performance with state-of-the-art cell segmentation algorithms based on machine learning.

To this end, we the Applicant has on Cellpose, a recently released deep learning approach for instance segmentation in biology as well as on previously released approaches such as Mask-RCNN and StarDist.

Data relative to Cellpose can be accessible at the following Internet links:
https://www.nature.com/articles/s41592-020-01018-x
https://github.com/MouseLand/cellpose
https://www.cellpose.org/
https://www.cellpose.org/dataset

Data relative to Mask-RCNN and to StarDist can respectively be found at the following address:
https://openaccess.thecvf.com/content_ICCV_2017/papers/He_Mask_R-CNN_ICCV_2017_paper.pdf
https://link.springer.com/chapter/10.1007/978-3-030-00934-2_30

Cellpose algorithm used a generalist model trained on a data set that contains over 70.000 segmented objects. Transfer learning is used to produce a cell instance segmentation specialist model trained on 89 images of in vitro cultured neurons that have been imaged using an epifluorescence microscope. This data set is accessible on the following address:
https://doi.org/doi:10.7295/W9CIL40217

In the present section, the Applicant has used these 89 images to train the device for instance-segmenting from scratch.

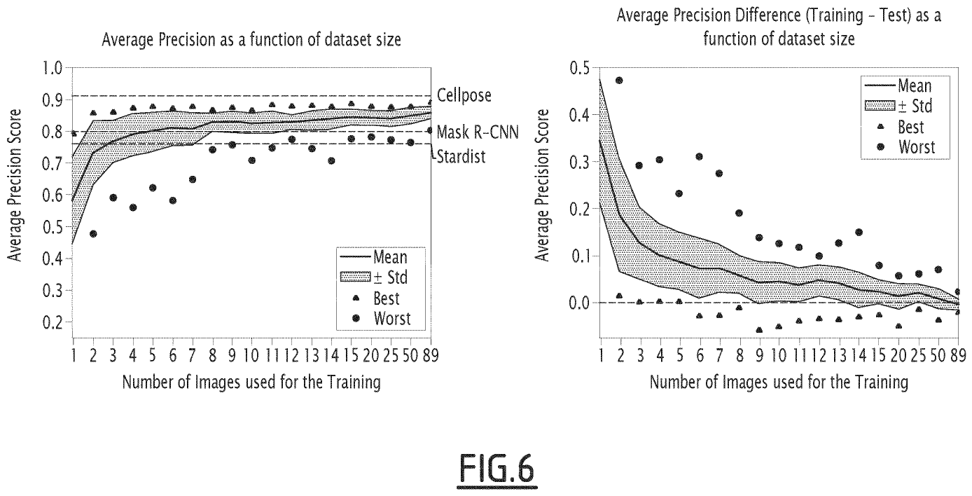

The left part of FIG. 6 shows the scores obtained on the test data set (composed of 11 images) by training the disclosed method on data sets of different sizes. Dotted lines indicate the results obtained by the other three methods above. It is interesting to note that disclosed method mostly outperformed Mask-RCNN and StarDist even on small training data sets. These results also show that the best AP50 precision obtained by the disclosed method was 0.89, a value comparable to the reported best performance of Cellpose (0.91).

The capacity of the disclosed method to generalize from few training events was also evident when the Applicant compared the scores obtained on training subsets with those obtained on the test set. As shown in the right part of FIG. 6, the difference of mean average precision between the training and test sets was close to 0 when only 9-10 images were used for training.

All in all, the disclosed method allows to obtain pipelines of comparable precision to state-of-the-art deep learning approaches. On top of its precision, the disclosed method allows to drastically reduce the learning data sets down to few images, a precious feature when performing complex image acquisition procedures on biological samples.

In the following paragraphs, a portfolio of applications of the disclosed method-based image analysis at different scales (from nanometer-size extracellular particles to millimeter-size tissues) are exposed. This enables to show the very good versatility of the disclosed method.

### Multi-Molecular Scale: Detecting and Measuring CTLs-Derived Extra-Cellular Particles

Recent findings revealed that the fight between CTLs and tumor target cells is not limited to lytic synapses, specialized cell-cell contact areas where lytic granules are secreted, but also occurs via the release of extra-cellular aggregates of lytic components and additional bioactive molecules named Supra Molecular Attack Particles. SMAPs might become a novel weapon in the arsenal of oncologists. It is therefore crucial to develop new methods to characterize these particles in order to better define their biological function and therapeutic potential. As individual CTL-derived SMAPs are small (~120 nm in diameter, as detected by D-STORM imaging), high-resolution imaging techniques are required for their visualization.

In a first application of the described method, the Applicant analyzed subcellular structures. Total Internal Reflection Fluorescence Microscopy (TIRFM) images of particles released from human polyclonal CD8+ CTLs and Alexa 647-conjugated wheat germ agglutinin (WGA; a red fluorescent probe that stains sialic acid and N-acetyl-glucosamine moieties of glycoproteins), and DiO (a green fluorescent lipophilic dye that stains hydrophobic lipid membranes) were kindly provided by Michael Dustin and Oskar Staufer, University of Oxford, UK.

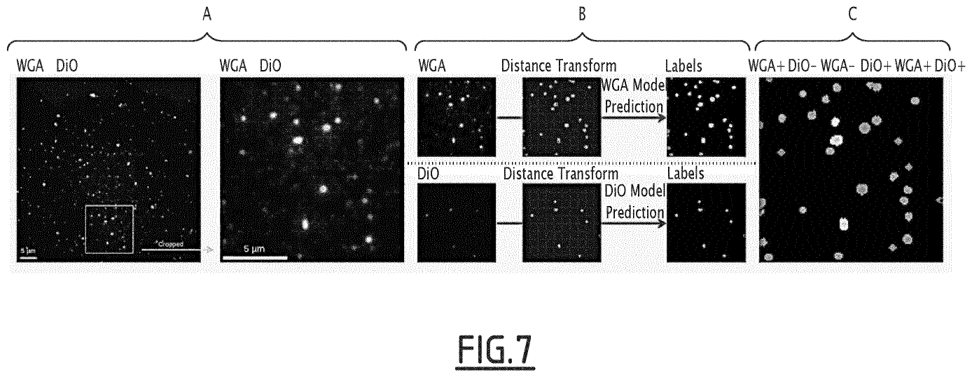

The population of particles included WGA+ (cyan), DiO+ (magenta) and double positive particles (lavender) by TIRFM (see part A of FIG. 7). Using the described method, the Applicant aimed at designing an automated procedure allowing to segment and identify single and double positive particles and to characterize their dimension. This used case enabled us to demonstrate the performance of the described method in the context of single-particle high-resolution imaging.

For each channel, the Applicant first trained the described method on a dataset consisting of one manually-labelled images, split into quarters. Note that, in order to better distinguish particles that were in close contact, the Watershed Endpoint (included in the case of FIGS. 3 to 5) was replaced by the function Local Max Watershed (this function is notably explained in the link:
https://people.cmm.minesparis.psl.eu/users/beucher/wtshed.html).

Based on 35 runs, the disclosed method achieved an AP50 score of 0.81 (±0.038) and 0.79 (±0.030) for WGA and DiO channel respectively, with a maximum score of 0.87 and 0.84 for WGA and DiO respectively. To assess generalizability, all IS pipelines were then tested on a dataset of one manually-labelled previously unseen image, split into quarters. Under these test conditions, the disclosed method achieved an average AP50 score of 0.73 (±0.084) and 0.76 (±0.091) for the WGA and DiO channels respectively, with a maximum score of 0.84 for WGA and 0.85 for DiO. These scores were deemed acceptable by experts given the difficulty to precisely manually annotate extracellular particles.

For each channel, the best overall pipeline (based on test and training fitness scores) was then applied to an image cohort containing an additional 9 images of CTL-derived extracellular particles. For the WGA channel, the best overall pipeline had a training fitness score of 0.87 and a test fitness score of 0.84. For the DiO channel, the best overall pipeline had a training fitness score of 0.81 and a test fitness score of 0.85. Part B of FIG. 7 shows a representative example of cyan and magenta particle segmentation obtained with the best pipeline out of the 35 runs performed. In order to identify double stained particles post segmentation, the WGA/DiO instances previously detected using the described method were tested for matching using a pairing mechanism based on the Intersection over Union (IoU) metric. Instances detected in the WGA and DiO channels with the IoU score above a threshold of 0.05 were identified as double positive instances. The entire process allowed the segmentation of three sets of particles: namely WGA+DiO+ (cyan), WGA-DiO+ (magenta) and WGA+DiO+ (see part C of FIG. 7).

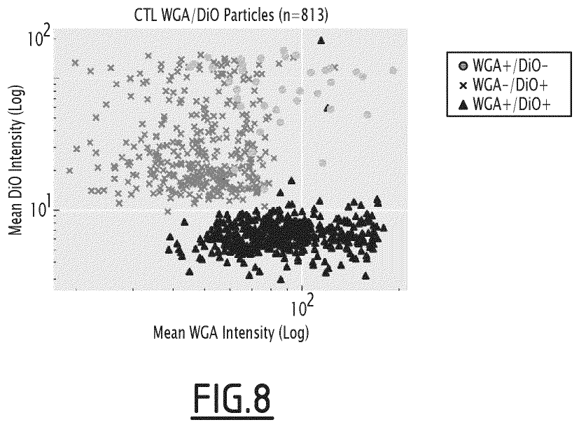

From these sets, the Applicant was able to readily calculate the mean fluorescence intensity and area of each instance as shown in FIG. 8. The panel displays a scatter plot of single WGA+DiO− (cyan), WGA-DiO+ (magenta) and WGA+DiO+ particles (orange) released from CTLs. This analysis proved capable of distinguishing extracellular vesicles (WGA-DiO+ particles) from putative SMAPs, which were previously shown to be WGA+ but negative for lipophilic membrane dyes.

Taken together, the above results show that the described method can successfully perform rapid and accurate instance segmentation of extracellular particles at multi-molecular scale, providing access to further analysis of a statistically relevant number of events. It is important to note that the pipeline generated by the described method can be exported to standard Python scripts, which can be readily re-used on additional images acquired in comparable experimental conditions.

### Sub-Cellular Scale: Assessing the Lytic Arsenal of Individual CTLs

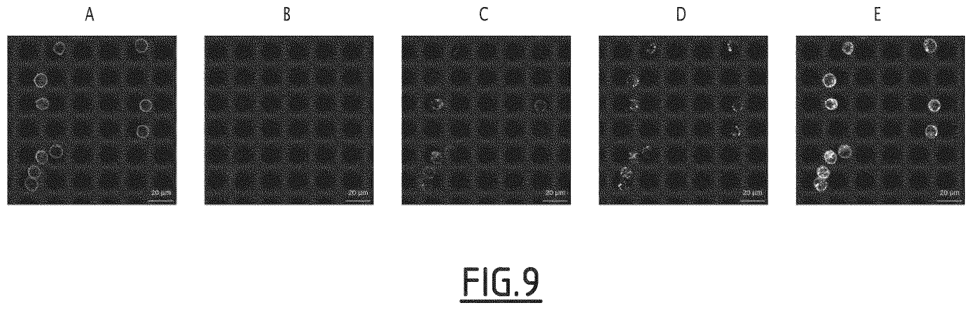

In a further step, the Applicant tested the capacity of the described method to automatically measure the expression of various molecules within cells, in order to classify individual cells on the basis of their molecular content. The Applicant focused on the CTL lytic arsenal by measuring the expression of various cytotoxic components in individual polyclonal human CTLs. Cells were stained with antibodies directed against CD45 (grayscale), perforin (magenta), granzyme B (GrzB, yellow) and LAMP-1 (cyan) (see FIG. 9).

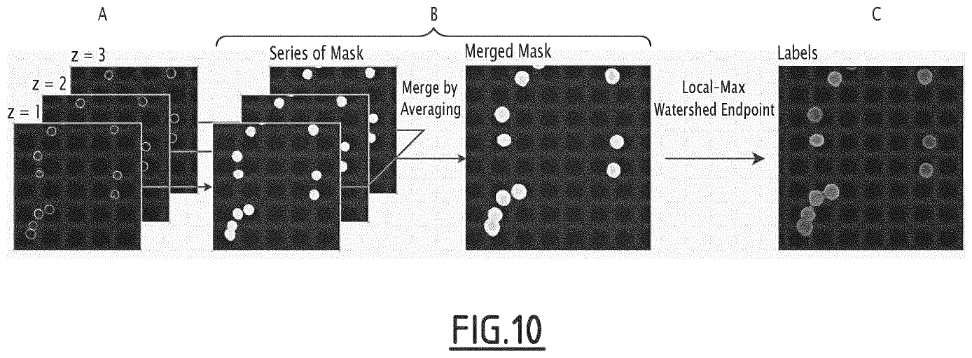

Staining for CD45, a molecule expressed on the surface of cells of the hematopoietic lineage, allowed the described method to identify the contour of individual cells, while the other markers were used to score CTL lytic arsenal. For this analysis, the Applicant applied the described method to series of z stacks on CD45 staining only (part A of FIG. 10). To achieve this aim, the Applicant upgraded the described method to segment cells in 3D stacks in order to provide accurate 2D masks of each identified cell.

The described method was sequentially applied to each layer of the z stack to produce initial Watershed masks of each z-stack. All the masks were merged with an averaging operator which allowed to obtain the maximal area of the cells in the z-dimension (part B of FIG. 10). Local Max Watershed was applied to produce the segmentation masks of the cells (individual segments, see part C of FIG. 10).

For this analysis, the training fitness was more stringent than in the previous analysis (AP with a threshold of 0.7 instead of 0.5) to avoid overfitting. The training dataset was limited to 5 images containing 45 cells, highlighting the capacity of the disclosed method to be trained for cell segmentation on a very small set of images. The disclosed method (35 independent runs) obtained a score of 0.929 (±0.064) on the training dataset and 0.825 (±0.029) on the test dataset that was composed of 4 images containing 34 cells.

Once the individual entities were segmented, the Applicant measured lytic component staining in each z section in order to constitute a feature vector for each cell. This vector contains both individual and combined counts of positive pixel, sums of pixel fluorescence intensities and average intensities measured in the different channels (see material and methods).

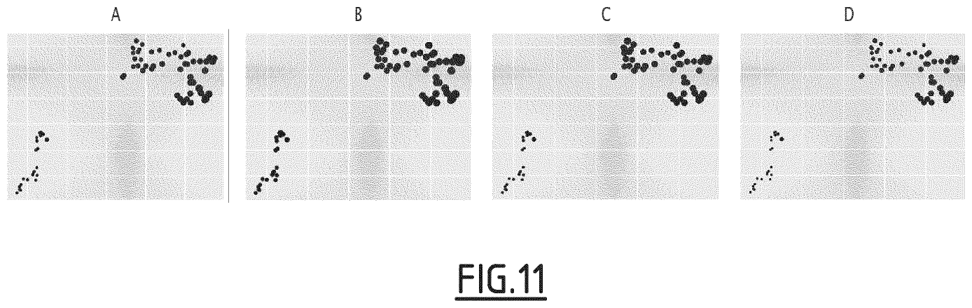

The gradient of expression of each lytic component within cells of the whole population is shown in parts A to C of FIG. 11. Part D of FIG. 11 shows the gradient of individual cell staining in the whole population for the three markers together.

The results provided by the described method-based analysis suggested the enrichment of the three markers of lytic machinery in the same neighborhood of the UMAP visualization. These results are consistent with the notion that CTL belonging to a polyclonal population exhibit a heterogeneous lytic arsenal with some CTL exhibiting a stronger expression of the lytic markers as compared to others.

Together these results underline the capacity of the described method to serve as a versatile tool for the analysis of molecular content in cells. This function can be instrumental to automatically assess staining intensities in a wide range of microscopy images.

### Cell-Cell Interface Scale: Measuring Features at Lytic Synapses

In a next step, the Applicant focused the analysis on lytic synapses. Here, the objective was to design an automatic procedure which would take 3D stacks of images of CTL in interaction with target cells (either non-pulsed or pulsed with the antigenic peptide) in input. This process was intended to identify the CTL-target cell conjugates.

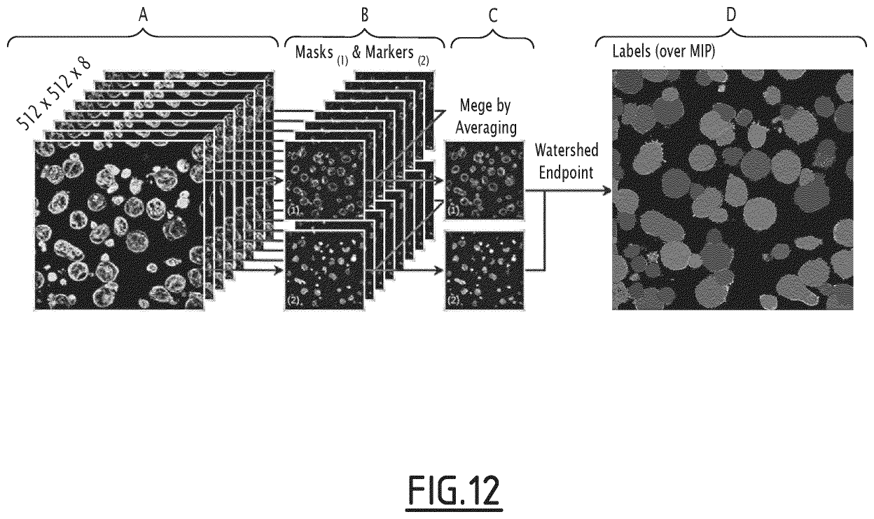

Cells were stained with DAPI (cyan, to detect CTL and target cell nuclei), with antibodies directed against b-tubulin (green, to visualize tubulin cytoskeleton in both cells) and antibodies directed against perforin (magenta, a lytic molecule expressed by CTL only) in order to allow the disclosed method to distinguish the cells (see Part A of FIG. 12).

As outlined in the procedure described in reference to FIG. 10, the disclosed method-generated pipelines were sequentially applied to each layer of the z stack. This process generated pairs of masks and markers (see part B of FIG. 12). All the obtained mask/marker pairs were then merged using an averaging function to produce one mask heatmap and one marker heatmap (see part C of FIG. 12). Watershed was then applied to the heatmaps to produce 2D masks containing instance segmentation of cells (see part D of FIG. 12).

At this step, each segmented instance corresponded to exactly one cell, either CTL or target cell. Knowing that the average dimension of CTLs and target cells, we excluded all entities with a surface <350 pixels (~24 μm²) and >6000 pixel (~417 μm²), which might correspond to cell fragments or big cellular clusters. Additionally, the Applicant also applied a morphological closing to smooth cell contours. At this step of the pipeline, the claimed method achieved an AP50 score of 0.718 (±0.035) on a validation set containing 150 unseen cells.

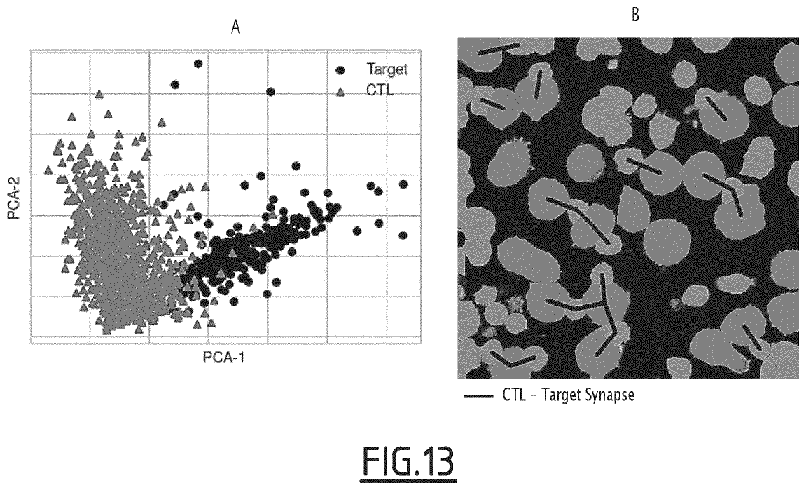

The next step, depicted in part A of FIG. 13, was to classify each instance as either CTL or target cell. To this end, the Applicant calculated, for each instance, its area and the intensity of DAPI (cyan), tubulin (green) and perforin (magenta) fluorescence, the Applicant considered these four features sufficient to separate the two populations since CTL are statistically smaller than target cells and express perforin. Unsupervised machine learning (PCA followed by Gaussian Mixture Model) was then used to separate the two population of cells. This method allowed us to reach an accuracy of 92.2% on a validation set containing 153 cells, as evaluated by experts.

Once the CTL and target cells were identified, we selected CTL/target cell conjugates on the basis of their contiguity using the following two complementary procedures: I) we calculated the distance between the centroid of the CTL and the target cell masks and kept only the cells with a distance less than 70 pixels (~18.5 μm). This procedure allowed us to keep in the analysis CTL and target cells with high probability of contact. II) In the selected conjugates, each target cell mask was slightly dilated in order to potentially intersect other masks. This procedure was required since instance segmentation produces distinct masks. If an intersection with a CTL mask was detected, the target cell was considered in conjugation with the T cell (see part B of FIG. 13).

Cumulatively, this procedure allowed the Applicant to keep in the analysis bona fide conjugates while excluding big cellular clusters and cell fragments. Each conjugate included in the analysis was verified by experts showing an accuracy of the combine procedure of 75.4% on 52 synapses.

In conclusion, the above results highlight a two-step approach, in which the disclosed method is able to identify cells that are then classified by machine learning into different cell populations on the basis of their size and staining features. This opens to the automatic high-throughput scoring of defined parameters of immunological synapse formation and of other cell activation/death parameters in cell-cell conjugates. All in all, it has been shown that the described method can synergize with state-of-the-art machine learning methods to create a hybrid AI approach able to assess and to interpret complex functional structures in biological images.

### Tissue Scale: Segmenting Tumor Nodules in Immunohistochemistry-Stained Tissue Samples

At a higher scale of imaging, it is proposed an end-to-end translational application of the disclosed method for tumor nodule segmentation in patients' tissue samples. The goal is to furnish to clinicians an easy to apply and fully interpretable and explainable tool that is automatically generated starting from a small annotated data set.

For an initial application, the Applicant profited of two off-the-shelf tissue sample cohorts of metastatic melanoma patients as described in the article by L. Filali et al. entitled ‘Ultrarapid lytic granule release from CTLs activates Ca²⁺-dependent synaptic resistance pathways in melanoma cells’. In this application, the described method was employed to create a segmentation mask of tumor nodules within immunohistochemistry (IHC) stained tissue samples based on staining with the melanoma cell marker Sox10.

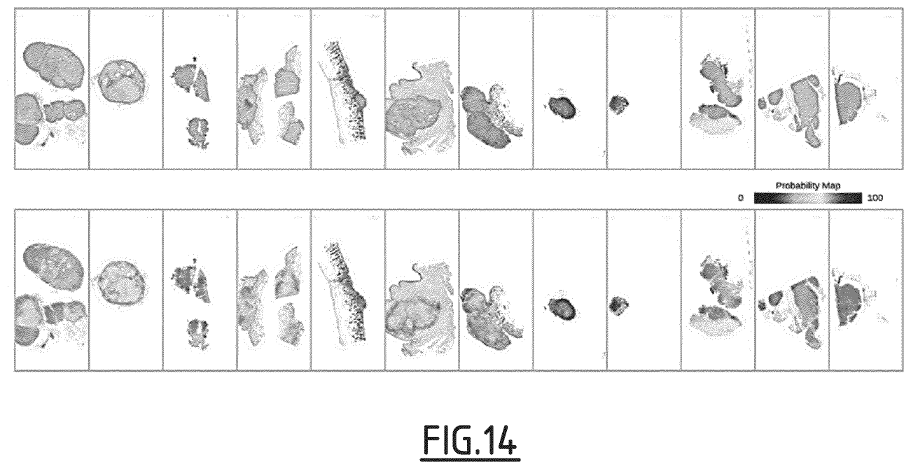

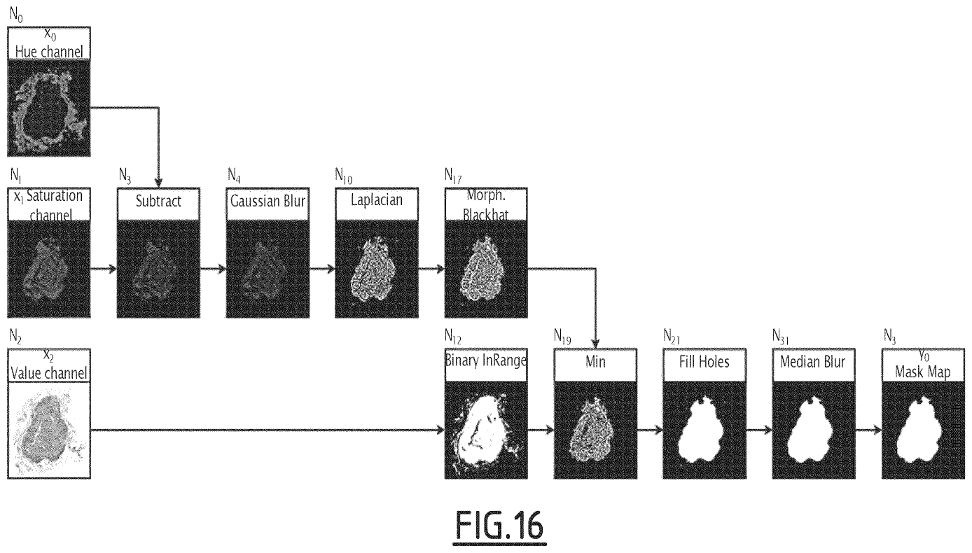

In the present section, the Applicant limited the analysis to a data set containing 24 images. FIG. 14 (upper images) depicts the 12 images used for training; FIG. 16 (upper images) depicts the remaining 12 images used for test. Both image series have been annotated by an expert pathologist (see edge lines).

Based on 100 runs, the disclosed method obtained a mean IoU score of 0.84 (±0.038) 0.038 on the training data set and of 0.82 (±0.062) on the test data set.

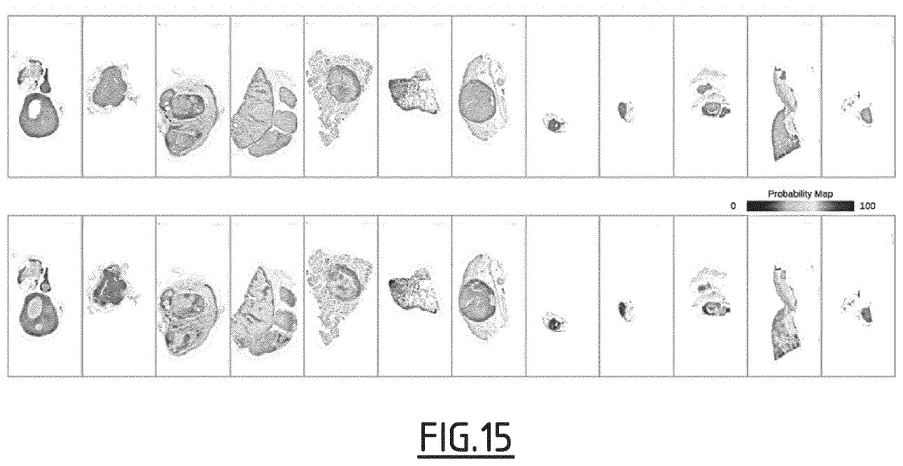

As shown in FIGS. 14 and 15 (lower images), the Applicant merged the prediction of 100 experts to generate heatmaps providing integrated representations of the obtained masks. To reach a consensus in line with expert pathologist annotation, only pixels with 75% of virtual experts agreeing on tumor area identification were displayed. In clinical settings, this threshold can be fine-tuned on the basis of the image cohort specificities and of the expert pathologist judgement.

Notably, each described method-generated algorithm could be interpreted and explained. As an example, the Applicant selected the pipeline that obtained the best IoU score and dissected its behavior (FIG. 16).

The first step (node 3) of this pipeline consisted in subtracting the Hue channel (node 0) from the Saturation channel (node 1), allowing to exclude the pixels corresponding to CD8+ T cells and to other cells belonging to the tumor microenvironment. Then the disclosed method used a Gaussian Blur filter (node 4) in order to smooth the previously obtained area. Next, the disclosed method chose a Laplacian filter (node 10) to detect the variations in the image obtained in node 4, thus delimiting the tumor borders. Interestingly, the sequence Gaussian Blur/Laplacian filters is frequently used by image analysts for image segmentation tasks. To highlight the segmented areas, the disclosed method used Morphological Black Hat (node 17) which reveals the small objects that are darker than their surroundings. All together, these initial calculations provided a rather accurate estimation of tumor areas.

In parallel, node 12 created a binary mask of the Value channel (brightness) allowing to establish a global map of the area of interest. A next remarkable step selected by the disclosed method consisted in merging the two maps with the min operator (node 19). This allowed to eliminate all pixels detected by the first calculation (results of node 17) that felt outside the area of interest. The pipeline next selected a Fill Hole filter in order to transform the selected area limits into a solid binary mask. A final step consisted in removing the noise from the edges of the mask using a Median Blur filter (node 31). In its whole, the described process allowed a sharp delimitation of tumor nodules in all the considered images. A dissection similar to the one we outlined above can be applied to each pipeline.

In perspective, this easily interpretable tool to rapidly segment tumor nodules, has the potential to allow automatic assessment of various parameters that are critical for cancer patient management, such as tumor nodule size, morphological features, tumor localization, its borders with surrounding tissue and distance from the resection margins.

### Description of FIGS. 6 to 16

FIG. 6 illustrates that the described method achieves comparable precision to state-of-the-art deep learning approaches.

The described method was trained 35 times on various numbers of images (ranging from 1 to 89). Its performance (measured on a test set of 11 images) was compared to results obtained by Cellpose, Mask-RCNN and StarDist on a training set of 89 images.

The plot on the left of FIG. 6 is a plot showing the Average Precision (AP50) of 35 pipelines for the indicated number of images used for training. Dotted lines indicate the results obtained by the other three methods.

The plot on the right of FIG. 6 is a plot showing the difference between scores obtained on training subsets with those obtained on the test data set by the 35 pipelines for the indicated number of images used for training. Dotted lines indicate the 0. Triangular and circular dots show the best and worse scores obtained by the claimed invention at each number of images used for training.

FIGS. 7 et 8 illustrate schematically the assessment of CTLs-derived extra-cellular particle composition and size.

Extracellular particle released by CTLs previously loaded with WGA and DiO were imaged using TIRFM.

Part A of FIG. 7 is a typical image depicting extra-cellular particles stained with either WGA (cyan), DiO (magenta) or both. The inset indicates the region of interest.

Part B of FIG. 7 represents two images on the left depict the individual channels. On each channel, the described method generated a model for instance segmentation (arrows) leading to labels via the Local Max Watershed Endpoint.

Part C of FIG. 7 illustrate schematically the classification of the labels. Each label was classified as WGA+, DiO+ and WGA+DiO+, their matching was evaluated on the basis of their overlap.

FIG. 8 represent a panel displaying individual dots representing single WGA, single DiO and double positive particles plotted on the basis of their fluorescence intensity. The size of individual dots reflects the size in μm² of each particle.

FIG. 9 represents schematically the staining for various CTL lytic components.

Human polyclonal CD8+ CTL were stained with antibodies directed against CD45 (a, gray), perforin (b, magenta), GrzB (c, yellow) and CD107a (d, cyan). Merged channels are shown in the panel of FIG. 9.

FIGS. 10 and 11 represent the result of a tridimensional (3D) analysis of lytic molecule content in individual CTL belonging to a polyclonal population.

In part A of FIG. 10, z stacks of images depicting CD45 staining were used as a 3D input to delimitate individual cells.

In part B of FIG. 10, the described method was sequentially applied to each layer of the z stack to generate the corresponding mask. The masks were aggregated using an averaging operator.

In part C of FIG. 10, the application of the Local Max Watershed Endpoint allowed to obtain bidimensional (2D) labels.

Parts A, B and C of FIG. 11 illustrate UMAP representation of the gradient of expression of each lytic component within individual cells.

Part D of FIG. 11 is a UMAP representation of merged lytic components.

FIGS. 12 and 13 illustrate a hybrid described method/AI approach to detect CTL/target cell conjugates.

Part A of FIG. 12 illustrates the interaction between Human clonal CTL and HLA-matched target cells that were stained with DAPI (cyan), an anti-b-tubulin Ab (green) and an anti-perforin Ab (magenta). Each series of z sections was used as a 3D input.

Part B of FIG. 12 illustrates the application of the same method to each z section to generate pairs of masks and markers.

Part C of FIG. 12 shows schematically that all masks and markers were merged to obtain one 2D mask heatmap and one marker heatmap.

Part D of FIG. 12 corresponding to the application of the Watershed Endpoint allowing to obtain 2D labels.

Part A of FIG. 13 corresponds to the unsupervised machine learning (PCA followed by Gaussian Mixture Model) was used to classify the two-cell population.

Part B of FIG. 13 corresponds to the visualization of cell classification. Colored masks (orange and blue) indicate the two class of cells (CTL and target cells respectively). Red lines indicate the formation of synapses between two contiguous CTL and target cells.

FIGS. 14 to 16 correspond to the segmentation of tumor nodules within IHC stained tissue specimens.

FIGS. 14 and 15 illustrate the 12 images used for training and 12 images used for test are depicted respectively. Green lines delineated expert pathologist annotation. Lower panels: predictions of 100 experts were merged to generate mask heatmaps.

FIG. 16 corresponds to the set of operations used to obtain the best IoU score.

### APPENDIX

### Mathematical Notations

Kartezio was developed using Python3 programming language and built mainly over Numpy, Opencv, Skimage, and Scipy. For the visualization, images and plots were generated using Matplotlib, Seaborn, Opencv, and ImageJ.

Parameters

| Symbol | Description |
|---|---|
| i ∈ [symbol] | Number of inputs for the CGP model; also the size of X |
| n ∈ [symbol] | Number of nodes for the CGP model |
| o ∈ [symbol] | Number of outputs for the CGP model; also the size of \hat{Z} |
| α ∈ [symbol] | Global arity for all the functions of the bundle |
| ρ ∈ [symbol] | Global number of parameters for all the functions |
| λ ∈ [symbol] | Number of children of the population involved in Evolution |
| | Strategy 1 + λ |
| μ | Mutation probability for functional nodes |
| ν | Mutation probability for output addresses |
| [symbol] | Number of iterations for the evolution loop |

Data

| Symbol | Description |
|---|---|
| X: {x₁ . . . xᵢ} | Formatted input vector of i elements |
| \hat{Z}: {\hat{z}₁ . . . zₒ} | Intermediate output vector of o elements |
| Ŷ | Finale output produced by the Endpoint ε |
| Y | Ground truth annotations |
| [symbol] | Training or test set; list of many X inputs |
| [symbol] | Training or test set annotations; list of many Y |

Model Components

| Symbol | Description |
|---|---|
| [symbol] | Genotype (genome, individual, chromosome) |
| [symbol] | Phenotype (syntactic graph, program) |
| [symbol] | Node |
| ε | Endpoint |
| [symbol] | Function set (Bundle) composed of φ functions f |
| [symbol] | Fitness minimization function |

Operators

| Symbol | Description |
|---|---|
| [symbol] | Decodes to parse one Genotype to the active Phenotype |
| ψ | Executes the Phenotype function sequence |
| ε | Executes the Endpoint to produce the final output Ŷ |

### Cartesian Genetic Programming

Genome. Cartesian Genetic Programming (CGP) considers a specific encoding of the syntactic graph within integer-based genome (see FIGS. 3 to 5). Each node [symbol] (encoded in a gene) of the graph is identified with the unique integer value i that the other graph nodes will address to connect the mathematical functions. Here, the genome [symbol] of a CGP oriented graph [symbol] is an m-by-n matrix where m is the number of nodes and is equal to the total number of functional nodes (η) and output nodes (o). n corresponds to the size of one node, which relies on 3 values: the unique function index from the function bundle [symbol] , the number of inputs for the functions (α), which correspond to the maximal arity of the functions from the library and the maximum number of parameters (ρ) required by the functions from the library. Formally, the genome can be written as 2 sub-matrices:

$$𝒢 = [ \begin{matrix}{𝒩}_{η \times n} \\ {𝒪}_{o \times n}\end{matrix} ] ∈ {ℳ}_{m \times n} ( ℕ ) where \begin{matrix}m = η + o \\ n = 1 + α + ρ\end{matrix}$$

### Nodes

A functional node [symbol] is a 1-D vector composed of 3 significant segments described as follows:

$${𝒩}_{i} ∈ {ℳ}_{1 \times n} ( ℕ ) : [ {b}_{i} , {C}_{i} , {P}_{i} ] where \begin{matrix}{b}_{i} ∈ [ 1 , φ ] \\ ∀ c ∈ {C}_{i} , c < i\end{matrix}$$

where the integer bᵢ indexes one of mathematical functions from [symbol] (Table S1), Cᵢ are addresses of upstream nodes within the graph that will be used as inputs of the node's function and Pᵢ are constant (but optimized) parameters of the function.

All functions from the library must be determinist and must return one 2D image which is identical to the input image in dimensions and type (generally encoded in uint8). Most of the time, one node operation consists of one function call from the OpenCV Python package. All functions must be image-size independent, which implies that the input and output for a given image is equivalent. However, there is no image size constraint for the model in both training and test datasets.

The first ι nodes, noted as X:{x₁ . . . xᵢ} are the receiving inputs (e.g. image channels) while the last o nodes represents the intermediate outputs \hat{Z}:{\hat{z}₁ . . . \hat{z}ₒ}.

An example of genome [symbol] [ι=3, η=6, o=2, α=2, ρ=1] with its nodes is illustrated in FIG. 3.

### Non-Evolvable Preprocessing Node.

The first stage of a standard image processing pipeline is the preprocessing or/and formatting of the raw data. Depending on the input images (e.g. transmission light images, fluorescent images, IHC tissues images, etc.) and the expected outcomes (e.g. cell identification, event counting, cell distance and interaction, etc.) needed to address a given biological question, the user can impose a preprocessing of the dataset. When loading the dataset, the preprocessing stage is done on-the-fly and produces a formatted input X for each entry of the dataset. For example, the default behavior for a standard bitmap image is X_{rgb}:[x₁=r,x₂=g,x₃=b]. For specific needs of certain datasets, any function can be used for preprocessing (e.g. HSV transformation, pyramidal mean shift filtering, etc.) including those requiring all three channels to operate. This can help evolution by providing important insight given by the domain expert.

### Non-Evolvable Endpoint

The Applicant also introduces a new component extending CGP to Instance Segmentation (IS) using a determined final function called Endpoint. It is the last processing step before evaluation. It is a substantial bottleneck, not subject to optimization, of the syntactic graph. Moreover, the endpoint is the only node allowing the outcome size and type to change. The Applicant uses Watershed Transform as the main algorithm to produce IS.

In cell segmentation, the cell nuclei are usually stained or visible, so it is possible to deduce good markers for a Marker-Controlled Watershed (o=2). These two endpoints produce a label map that is then assessed. After evolution, the genome endpoint can be enhanced with deployment features like ImageJ ROI generation based on labels. In semantic segmentation, the default endpoint is a Threshold (binary or to zero).

### Genome Decoding and Graph Execution

To generate an output from given inputs, the CGP genome [symbol] is first decoded to produce its phenotype [symbol] (Equation 1). [symbol] is then executed to produce the intermediary results [symbol] (Equation 2) which is provided as the input of the endpoint (Equation 3) to calculate the final output

[symbol]

$$𝒫 = δ ( 𝒢 ) \qquad ( 1 )$$

$${\hat{Z}}_{𝒢 , X} = ψ ( ( 𝒫 , X ) \qquad ( 2 )$$

$${\hat{Y}}_{𝒢 , X} = ε ( {\hat{Z}}_{𝒢 , X} ) \qquad ( 3 )$$

When used on 3D images, Equation 1 is used only once to obtain a unique syntactic graph which will be used for all z sections. Equation 2 is executed for each z-section X_{z} of the image. All [symbol] are then merged (averaged in the example Equation 4) to obtain the intermediary output [symbol] , which is in turn feeding the endpoint (Equation 3) to produce the final output

[symbol]

$${\hat{Y}}_{𝒢 , X} = ε ( \frac{1}{N} \times {\sum }_{z = 1}^{N} {\hat{Z}}_{𝒢 , {X}_{z}} ) \qquad ( 4 )$$

### Evolution

The disclosed method uses the 1+λ Evolution Strategy (ES). A first population (k=0) of genomes

$${𝒢}_{k = 0}^{n}$$

with n∈[0,λ] is initialized randomly and independently. These genomes then follow an evolutionary loop in which they will first be evaluated and the best genome

$${𝒢}_{k = 0}^{*}$$

selected based on evaluation score to produce the next parent genome

$${𝒢}_{k = 1}^{*}$$

is then mutated to produce λ offspring

$${𝒢}_{k = 1}^{n}$$

with n∈[1,λ]. The evolutionary loop (evaluation, selection, mutation) is repeated a finite number of [symbol] iterations to produce the final genome

$${𝒢}_{𝒦}^{n} .$$

The following section details each evolutionary operator, the 1+λ ES.

### Evaluation

To evaluate a genome [symbol] , this genome is first decoded as describe previously. The resulting graph is executed on each image of the training dataset [symbol] to obtain a set of predictions [symbol] . Predictions are confronted to the ground truth of the dataset [symbol] using a specific fitness function [symbol] which evaluates the prediction errors. This function is domain-specific (e.g. AP50 for instance segmentation or IoU for semantic segmentation) and must be defined for each task the disclosed method is used for. The genome evaluation is finally given by the average of prediction error:

$${fitness}_{𝒢} = \frac{1}{N} \times {\sum }_{i = 1}^{N} ℱ ( {𝒴}_{{train}_{i}} , {Y}_{{X}_{i}} )$$

### Selection

The objective is to minimize the prediction error over many iterations. The best genome is therefore selected among the offspring and the parent by selecting the smallest prediction error. If an offspring obtains a fitness strictly equal to the current parent, they are distinguished by minimizing the execution time of the graph to promote frugality in term of computational effort.

### Mutation

The parent generates λ new offspring by mutation. Mutations consist of randomly altering random values of the genome. As described in (REF Goldman), The disclose method performs mutations until the active graph changes. Random indices (i,j) are sampled in the whole functional submatrix: [symbol] gets a new independent value r, sampled as follows:

$${𝒢}_{i , j} = \{ \begin{matrix}r ∈ [ 1 , φ ] & if j = 1 \\ r ∈ [ 1 , i [ & if 1 < j < 1 + α \\ r ∈ [ 0.255 ] & if 1 + α < j < 1 + α + ρ\end{matrix}$$

The number of altered [symbol] values is calculated to respect the mutation rate parameter. Lastly, each output address has a probability to be replaced by a new random value r∈[1,ι+η].

### Benchmarking

The Applicant has trained the models with a η=30 nodes, λ=5 offspring over [symbol] =20,000 iterations. If the parent reached a score of 0, the evolution process stopped as no prediction error was made on the training dataset. The mutation probability was μ=0.15 for the functional nodes and ν=0.2 for the outputs. 35 independent runs were made for each experiment for statistical purposes. They were run on a bi Intel Xeon @6140 (2×18 cores, 2.30 GHz-3.70 GHz) with 192Go of memory.

### Applications of the Disclosed Method

### Use Case 1: Cell Image Library (FIG. 6)

The Applicant compared the disclosed method to 3 state-of-the-art instance segmentation algorithms: Cellpose, StarDist and Mask R-CNN. To this end, the dataset and the results for these three algorithms were taken from the references mentioned above for Cellpose. The data set was composed of 100 images of in vitro cultured neurons that have been imaged using an epifluorescence microscope. The data set was split into 89 images for training and 11 images for testing. No data augmentation was necessary for our approach.

In this study case, the disclosed method was composed of ι=2 inputs, corresponding the Tubulin and DAPI channels, and o=2 outputs, corresponding to the mask and markers necessary for the Watershed Transform non-evolvable endpoint. Generated syntactic graphs were evaluated using the Average Precision

$$( AP = \frac{TP}{TP + FP + FN} )$$

metric calculated with the standard Intersection over Union (IoU) between the predicted mask and the ground truth. A threshold of t=0.5 was applied to decide the correctness (true-positive) of the predicted mask, as described in the references mentioned above for Cellpose.

The disclosed method was benchmarked on different training dataset sizes, ranging from 1 image to 89 images. For each size of dataset, images were randomly selected from the initial 89 training images. Each trained solution was evaluated with 11 test images. Experiments were repeated 35 independent times for statistical purposes.

### Use Case 2: SMAPs (FIGS. 7 and 8).

Because of the intensity difference between channels, the data set was split into two datasets, one to generate a WGA specialist model and one to generate a DiO specialist model. The same procedure was applied to both WGA and DiO data sets. Each data set included one training image and one testing image of CTL-derived extracellular particles. Training and testing sets were augmented by splitting each image into four quarters. The final post-segmentation analysis was made using the test and training images combined with nine previously unseen images.

The disclosed method used ι=1 channel either for WGA or for DiO and o=1 outputs that produces mask. This mask was passed to the Local-Max Watershed non-evolvable endpoint, which consisted of creating a Distance-Transform (DT) map from the mask to find local-max (peaks). Together the peaks and the smoothed gradient of the DT were provided as input to Watershed Transform. Generated syntactic graphs were evaluated as described in the first study case.

Once trained, both models generated masks containing prediction of WGA particle and DiO particle instances. The two masks were merged using the same procedure to evaluate mask prediction to expected ground truth (IoU with a threshold of 0.05).

### Use Case 3: Lytic Arsenal (FIGS. 10 and 11)

From the original set of 19 images, 5 images were selected for the training set and 4 for the test set. Each 3D image was composed of 4 channels. To reduce the computational cost, we resized the images (halved the size). We chose a threshold t=0.7 for the fitness function (AP70) to be more stringent with the predicted mask.

To process a 3D image, we provided the z-sections of t=1 channel (CD45) to the model, which generates o=1 mask. All the masks were averaged to produce one final mask of the whole 3D image. We then applied the Local-Max Watershed Endpoint to produce the final 2D instance segmentation.

Cells were segmented from the 19 original images using the best model out of 35 runs. 161 cells were filtered from predicted cells using their pixel area (2000px<area<14000 px). For each cell, we calculated intensity features (see below) based on the Perforin, Granzyme B and Cd107a channels. All the cell's feature vectors were then used to generate the UMAPs of FIG. 10. To this end, we used the following parameters to the UMAP function: dimensionality reduction down to 2 components, using following parameters: n_neighbors=15, min_dist=0.01.

### Use Case 4: Synapses (FIGS. 12 and 13)

Four 3D images (using the z-stack function) were acquired. These large images were cut into a 3×3 grid, with a depth interval set for each tile (adapted to the focus). Images with high background noise and culture well edges were removed, thus giving a total of 32 selected images. We randomly extracted 8 images for the training set and 4 for the test set. The models handled ι=2 channels (Tubulin, DAPI) and used the Watershed endpoint (o=2). Similarly to the previous application, each z-section produced one markers map and one mask map, which were averaged individually before being passed to the Endpoint. In that case, the models segmented cells with no distinction of types. Over the 32 images, predicted cells were filtered by pixel area (350<area<6000).

Segmented cells were then classified as either CTL or target by using their intensity feature vector (see below) combined with their area. Unsupervised learning was used for classification using first Principal Component Analysis (n_components=“mle”[https://vismod.media.mit.edu/tech-reports/TR-514.pdf]) followed by a Gaussian Mixture Model (GMM) (n_components=2, covariance_type=“tied”).

Finally, CTL/target synapses were detected when the Euclidian distance between the centroids of a CTL and a target cell was less than 70 px (~nm). The target cell masks of potential synapse were then dilated (morphological dilation) to assess potential overlapping with CTL mask. A valid CTL/target synapse was detected if at least one pixel was overlapping.

### Use Case 5: Tumor Nodules (FIGS. 14 to 16)

A set of 24 whole-slide images from the clinical cohort was assembled for training and testing, including 12 images from each clinical site (Institut Universitaire du Cancer de Toulouse and Centre Hospitalier Universitaire de Bordeaux). Images were allocated in a randomized fashion into the training (n=12) and testing (n=12) cohorts. Whole-slide high-resolution images were first saved at their lowest resolution level, strongly reducing image size. Images were preprocessed by transforming R-G-B channels into H-S-V color space. The disclosed method's models were trained with ι=3 inputs and is terminated with a Threshold to zeros endpoint (o=1). Evaluation was made using the simple IoU Fitness function.

100 models were trained to segment tumor nodules. Each prediction from individual models was normalized (minmax scaler). All 100 predictions were merged by averaging the values pixelwise. All in all, the heat map H of one slide X is obtained by:

$$ℋ = \frac{1}{N} \times {\sum }_{i = 1}^{N} \frac{{\hat{Y}}_{{𝒢}_{i} , X} - min ( {\hat{Y}}_{{𝒢}_{i} , X} )}{max ( {\hat{Y}}_{{𝒢}_{i} , X} ) - min ( {Y}_{{𝒢}_{i} , X} )} where N = 100$$

The heat maps were then thresholded to zeros (t=0.25) to produce the heat maps presented in FIGS. 14 and 15.

### Intensity Feature Vector

This vector contained individual and combined counts of positive pixels, the sum, and the average pixel fluorescence intensities. Combined counts were calculated by first applying a binary threshold to determine the positive pixels within each channel. Each pixel of a given cell mask incremented a counter corresponding to its combination of positive channels. All the counters, augmented with the total count, the sum and the average fluorescence intensity for each channel were gathered into the intensity feature vector. The length [symbol] of the vector was determined by the number of channels [symbol] :

$$ℓ = {2}^{𝒞} + 3 \times 𝒞$$

### Image Acquisition and Processing

### Preparation of Extracellular Particles and Single Particle Imaging

For preparation of extracellular particles (EPs), CD8+ human primary T cells were isolated from healthy donor blood with negative selection kits (RosetteSep Human CD8+ T cell Enrichment Cocktail, STEMCELL Technologies, UK) following the manufacturers instruction. Peripheral blood samples were provided from the National Health Service under ethics agreement number 11/H711/7. CD8+ cells were expanded after isolation by addition of anti-CD3/anti-CD28 T-cell activation beads (Dynabeads ThermoFisher Scientific, UK) at 25 μl/106 cells and with 5000 Units/ml recombinant IL-2 for 3 days following the manufacturer's instructions. Subsequently, the magnetic beads were removed and cells were rested for 4 days at 106 cells/ml. For all incubation steps, cells were routinely cultured in RPMI (Gibco) medium supplemented with 10% fetal bovine serum, 1% penicillin/streptomycin, 1% L-glutamine, 1% non-essential amino acids and 50 mM HEPES in cell culture treated flasks at 37° C., 5% CO₂ and 100% humidity.

After resting, cells were transferred to fully-supplemented culture medium containing exosome-depleted serum (Thermo Fischer Scientific, UK) and cultured for 48 hours. For EP isolation, the culture medium was subsequently collected (total of 50 ml) and cell were removed by centrifugation for 10 min at 300 g. Larger particles and cell debris were removed by centrifugation for 20 min at 900 g. Subsequently, EPs were collected by centrifugation for 60 min at 100,000 g and at 4° C. The EP pellet was resuspended in 1 ml phosphate buffered saline (OBS) and stored until further use at −20° C. Repeated thawing and freezing cycles were avoided.

The EP solution (total protein concentration of 137 μg/ml) was diluted 1:10 with PBS and stained with a final concentration of 40 μg/ml AlexaFluor647-coupled wheat germ agglutinin (ThermoFisher Scientific, UK) and 20 μM DiO (ThermoFisher Scientific, UK) for 1 hour at 4° C. in the dark. 150 μl of the EP sample were then deposited onto clean glass coverslip (SCHOTT UK Ldt, Stafford, UK) fixed to flow chambers (sticky-Slide VI 0.4, Ibidi, Thistle Scientific LTD, Glasgow, UK) that were coated with 0.1 mg/ml poly-L-lysine (Sigma Aldrich, UK) for 15 min and washed twice with PBS before addition of EPs. The EPs were incubated for 30 min at 4° C. in the dark to allow for EP binding on the surface. Excess dye and non-bound EPs were washed from the flow channels by washing twice with PBS. Samples were subsequently imaged by total internal reflection microscopy (TIRFM). For TIRFM imaging an Olympus IX83 inverted microscope (Keymed, Southend-on-Sea, UK) equipped with 405-nm, 488-nm, 561-nm and 640-nm laser lines and a Photomertrics Evolve delta EMCCD camera was used. Images were acquired with a 150×1.45 NA oil-immersion objective.

### Confocal Microscopy

### Staining for CTL Lytic Components

Total CD8+ T cell were purified from healthy donor blood samples using the RosetteSep Human CD8+ T Cell Enrichment Cocktail (StemCell Technologies) following the manufacturers instruction. Blood samples were collected and processed following standard ethical procedures after obtaining written informed consent from each donor and approval by the French Ministry of the Research (transfer agreement AC-2014-2384). Approbation by the ethical department of the French Ministry of the Research for the preparation and conservation of cell lines and clones starting from healthy donor human blood samples has been obtained (authorization no. DC-2018-3223).

CD8+ T cells were cultured in RPMI 1640 medium supplemented with 5% human AB serum (Institut de Biotechnologies Jacques Boy), 50 μM 2-mercaptoethanol, 10 mM Hepes, 1 Å~ MEM-Non-Essential Amino Acids (MEM-NEAA) Solution (Gibco), 1 Å~ sodium pyruvate (Sigma-Aldrich), ciprofloxacin (10 μg/ml) (AppliChem), human recombinant interleukin-2 (rIL-2; 100 IU/ml), and human rIL-15 (50 ng/ml) (Miltenyi Biotec). CD8+ T cells were collected 7 days after activation using anti-CD3/anti-CD28 T-cell activation beads (Dynabeads ThermoFisher Scientific) at 2.5 μl/106 cells. Cells were washed in serum-free RPMI 1640 and allowed to adhere to poly-L-lysine (Sigma Aldrich) coated slides (Erie Scientific, ER-208B-CE24) at 37° C., 5% CO₂ for 10 min. Cells were then fixed with 3% paraformaldehyde (MP Biomedicals) for 10 min at room temperature, washed twice with PBS and subsequently permeabilized with 0.1% saponin (Sigma), 3% bovine serum albumin (Sigma) for 10 min at room temperature. Cells were stained in a two-step process with primary antibodies followed by isotype matching secondary antibodies all at 10 μg/ml. Both steps were performed for 1 h at room temperature. We used the following antibodies: Anti-human perforin mAb (clone δG9, IgG2b, BD 556434) followed by goat anti-mouse IgG2b AlexaFluor647 (Thermofisher A-21242), anti-human CD107a rabbit Ab (polyclonal, Abcam ab24170) followed by goat anti-rabbit AlexaFluor555 (Thermofisher A32732), anti-human granzyme B mAb (clone GB11, IgG1, Thermofisher MA1-80734) followed by goat anti-mouse IgG1 AlexaFluor488 (Thermofisher A-21121), and anti-human CD45 rat Ab (clone YAML501.4, Thermofisher MA5-17687) followed by goat anti-rat AlexaFluor405 (Thermofisher A48261).

The samples were mounted in 90% glycerol-PBS containing 2.5% DABCO (Fluka). Randomly selected cells were imaged with a LSM 780 confocal microscope equipped with a ×63-NA 1.4 oil immersion Plan-Apochromat objective (Zeiss), zoom 1.0. Images were acquired as z-stacks with an interval of 0.75 μm.

Staining for immunological synapse detection. Target cells were either unpulsed or pulsed with 10 μM antigenic peptide for 2 h at 37° C. in RPMI 5% FCS/HEPES and washed three times. Conjugates were formed by 1 min centrifugation at 455 g, incubated for 15 min, gently disrupted and seeded on Poly-L-Lysin coated slides and fixed with 3% paraformaldehyde at 37° C. Cells were then permeabilized with 0.1% saponin (in PBS/3% BSA/HEPES), and stained with anti-human perforin mAb (10 μg/ml, clone OG9; BD Pharmingen) followed by AlexaFluor555 goat anti-mouse IgG2b (10 μg/ml; Invitrogen) and anti-□-Tubulin mAb (1 μg/ml, clone DMA1; Sigma) followed by AlexaFluor488 goat anti-mouse IgG1 (10 μg/ml; Invitrogen). The samples were mounted in 90% glycerol-PBS containing 2.5% DABCO (Sigma) supplemented with DAPI (1 μg/ml; Invitrogen) and examined using a LSM 780 (Zeiss) confocal microscope over a ×63 Plan-Apochromat objective (1.4 oil). 3D images (using the z-stack function) were acquired.

### Patient Cohort

The established melanoma clinical cohort (previously described here REF Liza) was comprised of patients treated for advanced melanoma both at the Oncodermatology Department of the Institut Universitaire du Cancer de Toulouse (IUCT) and at the Centre Hospitalier Universitaire (CHU) de Bordeaux. Samples in Toulouse were stored at the CRB Cancer des Hôpitaux de Toulouse collection. In accordance with French law, this cancer collection was declared to the Ministry of Higher Education and Research (DC 2009-989) and a transfer agreement was obtained (AC-2008-820) after approbation by ethical committees. Samples in Bordeaux were stored at the Cancer Biobank of CHU Bordeaux collection. In accordance with French law, this cancer collection was declared to the Ministry of Higher Education and Research (DC 2014-2164) and a transfer agreement was obtained (AC-2019-3595) after approbation by ethical committees. Patients with available formalin-fixed, paraffin-embedded (FFPE) tumor blocks at the Department of Pathology were included in the analysis.

### Immunohistochemistry

CD8, CD107a and Sox10 were visualized by multiplex immunohistochemistry for the entire tumor nodule and surrounding tissue. The Discovery ULTRA (Ventana Medical Systems, Innovation Park Drive Tucson, Arizona 85755 USA, ROCHE) was used for automated staining. After dewaxing, tissue slides were heat pre-treated using CC1 buffer (05424569001, ROCHE). Slides were stained using the RUO Discovery Universal procedure (v0.00.0370) in a 3 step protocol with sequential denaturation (CC2 buffer (pH6), at 100° C., 05279798001, ROCHE). Tissue slides were incubated using primary antibodies CD107a (clone D2D11, #9091, Cell Signaling technology, Inc.), CD8 (clone C8/144B, M7103, Agilent technologies) and Sox10 (clone SP267, 07560389001, ROCHE) in Envision Flex diluent (K800621-2 Agilent Technologies). Targets were then linked using the OmniMap anti-rabbit (05269679001, ROCHE) and OmniMap anti-mouse (05269652001, ROCHE) HRP conjugated secondary antibodies. Visualization of the different targets was performed using Discovery Silver (07053649001, ROCHE), Purple (07053983001, ROCHE) and Yellow (07698445001, ROCHE) detection kits. Tissue slides were counterstained using Haematoxylin (05277965001, ROCHE) enhanced by Bluing reagent (05266769001, ROCHE) and mounted with xylene-based mounting medium (Sakura TissuTek Prisma, Sakura Finetek Europe B.V., The Netherlands). IHC slides were then digitized with a Panoramic 250 Flash II digital microscope (3DHISTECH, Budapest, Hungary) equipped with a Zeiss Plan-Apochromat 20× NA 0.8 objective and a CIS VCC-FC60FR19CL 4 megapixels CMOS sensor (unit cell size 5.5×5.5) mounted on a 1.6× optical adaptor, to achieve a scan resolution of 0.24 μm/pixel in the final whole slide image. A set of twenty-four whole-slide images from the clinical cohort was assembled for training and testing, including twelve images from each clinical site (Institut Universitaire du Cancer de Toulouse and Centre Hospitalier Universitaire de Bordeaux). Images were allocated in a randomized fashion into the training (η=12) and testing (η=12) cohorts prior to analysis.

### CONCLUSION

The present method here uses Cartesian Genetic Programming (CGP) as a means of optimizing a function in the form of a mathematical graph.

Such method enables to generate instance segmentation programs in the form of graph with a reduced energy cost with relation to deep learning approaches, from which the present method strongly differs.

For this, the method provides the user with the possibility of adapting the method to different formats and different types of biomedical images thanks to the preprocessing.

The method also proposes to uses CGP for solving the instance segmentation issue by using a fixed and non-changing final function, which is the estimating function. By combining such estimating function, notably with a Watershed function, with CGP, the trained conversion function has the ability to achieved the instance segmentation and is written in a language comprehensible to a human being (with comparison to a neural network for which the weights have no physical signification).

This application to the instance segmentation issue is very original in so far as CGP is generally used for scalars and manipulation of scalars, meaning that an image is the input and a value is the output whereas, for the present method, both the input and the output are images.

The present method also has the advantage to require less training data than other known method while providing with the same level of performance.

This means that the present method has the specificity of enabling a good generalization of the algorithm on training data.

As a specific example, the training data can be images with a reduced resolution (reduced size) to obtain a trained conversion function. Said trained conversion function has good performance with images of full resolution.

This means that the trained conversion function is adapted to treat images with a first resolution based on a training on images with a second resolution, the second resolution being strictly inferior to the first resolution.

For instance, the ratio of the second resolution to the first resolution is inferior to 80%, preferably inferior to 50%, advantageously inferior to 10%.

This enables to reduce greatly the annotation burden since the images to be annoted have a reduced size.

1. A method for determining at least one physical value in data, the method being computer-implemented, the method for determining comprising:
a training phase during which a converting function of a device for determining at least one physical value in data is trained, the device being adapted to apply:
an estimating function adapted to estimate the at least one physical value based on input data, and
a conversion function on incoming data to obtain input data for the estimating function,
the training phase comprising the steps of:
obtaining a dataset whose elements are incoming data and the corresponding physical value and a set of predefined operations, and
implementing cartesian genetic programming on the set of predefined operations and the dataset to obtain a trained conversion function maximizing a performance criteria for the device for estimating,
a use phase during which the trained conversion function is used, the use phase comprising the steps of:
providing real incoming data,
applying the trained conversion function on the real incoming data, to obtain real input data, and
applying the estimating function on the real input data, to obtain the estimated physical value.

2. The method for determining according to claim 1, wherein each real incoming data are data coming from a sensor.

3. The method for determining according to claim 1, wherein each data is an image.

4. The method for determining according to claim 1, wherein each data has a specific format, each operation of the set of operations keeping the format between the data inputted to the operation and the data outputted by the operation.

5. The method for determining according to claim 1, wherein each data has a specific format, the format of the incoming data being different from the format of the input data inputted to the estimating function.

6. The method for determining according to claim 1, wherein determining at least one physical value in data corresponds to a task, the task being chosen among counting, segmentation, instance segmentation, generation, classification, and denoizing.

7. The method for determining according to claim 6, wherein the task is the identification of biological objects in an environment.

8. The method for determining according to claim 6, wherein the task is the instance-segmentation of biological objects in an environment.

9. The method for determining according to claim 7, wherein the biological objects are cells or subcellular particles.

10. The method for determining according to claim 1, wherein each operation of the set of predefined operations is chosen among a filter, a morphological operation and an element-wise operator.

11. The method for determining according to claim 1, wherein the estimating function is a Watershed function.

12. The method for determining according to claim 1, wherein the estimating function is a Circle Hough Transform.

13. The method for determining according to claim 1, wherein the performance criteria is minimizing the error in the determination of the at least one physical value.

14. (canceled)

15. A computer-readable storage medium comprising instructions which, when executed by a computer, cause the computer to carry out the steps of a method according to claim 1.
